(19) United States
(12) Patent Application Publication
(10) Pub. No.: US 2010/0180218 A1
(43) Pub. Date: Jul. 15, 2010

(54) EDITING METADATA IN A SOCIAL NETWORK

(75) Inventors: Jeffrey Scott Boston, Wappingers Falls, NY (US); Bernice Ellen Rogowitz, Ossining, NY (US); Mercan Topkara, Thornwood, NY (US); Stephen P. Wood, Thornwood, NY (US)

Correspondence Address: MICHAEL BUCHENHORNER, P.A., 8540 SW 83 STREET, MIAMI, FL, 33143, US

(73) Assignee: INTERNATIONAL BUSINESS MACHINES CORPORATION, Armonk, NY (US)

(21) Appl. No.: 12/354,651

(22) Filed: Jan. 15, 2009

(51) Int. Cl. G06F 3/048; G06Q 99/00; G06F 17/30

(52) U.S. Cl. 715/759; 715/808; 707/E17.044; 705/319

(57) ABSTRACT

A system and method for server-side method for editing metadata in a file, the method including steps of: receiving from a user a request for editing the metadata in the file; presenting a window to the user for display on a user's screen wherein the window displays properties of the metadata; receiving from the user an edit to the metadata properties; and updating the metadata properties with the edit received from the user, for producing an updated metadata.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of social tagging, and more particularly relates to the field of editing of social tags.

### BACKGROUND OF THE INVENTION

Social tags are user-generated labels providing information about the content of a document, image, book, music, and video. Tags are a form of metadata. Tagging systems have emerged that allow users to tag information in text, images, web pages, software, music and video. The tagging systems allow communities of users to annotate shared content with free form text. This is called collaborative tagging in which new tags are added collaboratively but there is no actual editing of prior tags.

Collaborative editing as applied to web-based systems have proven to be quite popular and is most familiar in applications such as “Wikipedia, the free encyclopedia.” Social on-line networking is the interaction among a network of persons having something in common, such as Facebook (a college student network) and del.icio.us (a social bookmarking service). Since social networking systems are open to many users, there can be a proliferation of incorrect or incomplete tags. Another problem is that they restrict the user to tagging the full content of the document (video document). Large, complex content documents such as video documents are tagged at a very high level, thus diluting their potential value for search.

Current systems do not provide a mechanism for correcting or editing tags. If an incorrect or incomplete tag is noticed, the users' only alternative is to add a new tag and in some systems rate this tag low. This means that the quality of a search based on these tag metadata would be noisy, not providing the best search results.

Likewise, such input to recommender or data mining solutions would not produce crisp results. Improving tag quality, thus, would have great benefit. Here are some problems with known tagging methods:

a) Multiple repetitive tags for particular information, leading to clutter;

b) Incorrect information preserved in tags (typos or incorrect identifications or notations); and

c) Metadata clutter and misinformation provides bad input to search, recommender and data mining solutions;

These problems are amplified as the volume of text and multimedia content and associated tags increases. For example, systems are quickly emerging that capture descriptive metadata (e.g., cameras that automatically encode the time and date a picture was captured), text labels, annotations, transcriptions and comments, information about video clips, images, audio recordings, and so forth. These systems are vulnerable to proliferation of tagging problems as previously discussed.

Known approaches to social editing (users collaboratively edit information on the web) include:

1. Editing content collaboratively (any wiki system such as Wikipedia)

2. Communities fixing transcriptions generated by speech-to-text recognition system: This system allows communities to work on the same copy sequentially, in the sense that only one person can update the transcription at the same time. Next person can later work on the copy generated by the previous one. (see Viascribe; US Pub. No. 2006/0072727 A1)

3. Communities adjusting speed of text presentation locally to align with audio version of the book (Audio Books).

### SUMMARY OF THE INVENTION

Briefly, according to an embodiment of the invention a method includes steps or acts of receiving from a user, a request to edit a tag in the file that is shared in a social network; presenting a window to the user for display on a user's screen wherein the window displays properties of the metadata; receiving from the user an edit to the metadata properties; and updating the metadata properties for producing an edited metadata.

According to another embodiment an information processing machine or system includes an interface configured for: receiving from a user a request to edit the metadata in a file and receiving from the user an edit to the metadata; a processor configured for including the edit in the metadata; and an output device configured for sending a screen from the file to the user for display on a user's screen wherein the screen displays the metadata. The system permits a one-to-one interaction, but it is most advantageously used for many-to-many interactions among users, where users can add new tags and everyone can edit (as restricted by the access control set by the creator of that tag).

The method can also be implemented as machine executable instructions executed by a programmable information processing system or as hard coded logic in a specialized computing apparatus such as an application-specific integrated circuit (ASIC).

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 shows a tagged video image according to an embodiment of the present invention;

FIG. 2 shows a system for tagging according to an embodiment of the present invention;

FIG. 3 is a high-level block diagram of the information processing system of FIG. 2, according to an embodiment of the present invention;

FIG. 4 is a flow chart for creating a tag, according to an embodiment of the present invention;

FIG. 5 is a flow chart for editing the tag of FIG. 4, according to an embodiment of the present invention;

FIG. 6 is a screenshot of a video image with its associated tags, according to an embodiment of the present invention;

FIG. 7 is a screenshot of the overlay window, according to an embodiment of the present invention; and

FIG. 8 is a screenshot of the sharing options, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

We describe a method, machine and information storage medium for allowing a community of users to collaborate on improving the quality of tags attached to shared content by allowing the community to add, edit and delete tags. In this document we will refer to this as “metadata editing” or “tag editing.”

It has been noted that the quality of textual tags as measured by their success as search terms benefit from collaborative wisdom. One would think that opening up the tags for community editing would make them more vulnerable to mistakes and clutter, yet the opposite is true. Tests show that performance increases were recorded with successive user editing when the users could see each other's tags. Being able to edit or delete previous tags actually produces the most accurate set of tags (wiki-style editing). With increased community contribution, tag proliferation actually decreases, thereby reducing clutter, while performance increases. The wisdom of the crowds increases the value of the tags, converging on fewer, better search terms. When users can see contributions from others, there are fewer additions and fewer duplicate tags.

A method, according to an embodiment of the invention can be used to improve the quality of many different types of metadata, including:

Text tags: tag label, annotations, comments

Descriptive tags (such as time and place an image was captured)

Video tags: tag label, temporal interval, spatial location

Image tags: tag label, space, content (e.g., color, filter, morph, collage)

Audio tags: tag label, temporal interval when point of interest occurred

Refining tags can lead to a significant improvement in the quality of searches of the content identified by the “micro-tags.” There is a growing interest in using tags for search terms, therefore it would be of great benefit to have a system that allows a user community to clean up “tag clutter” and correct any individual peculiarities of communal tagging output, by allowing tags to be edited and deleted. According to an embodiment of the invention, there is no super-user supervising the editing. In this system the users within the community control the quality of the editing.

Enabling editing in combination with social tagging provides a mechanism whereby the quality of the metadata provided in the tags will continue to improve based on user activity. It has been shown that shared content improves when a large population contributes to its creation (e.g., Wikipedia). According to an embodiment of the invention, it is the metadata about shared content that users edit, and continue to improve. The cumulative activity of a user population editing tags will improve the overall quality of the metadata with a lower ratio of noise (tag clutter), as the users collaborate on keeping the data clean, accurate and usable. If the quality of the metadata improves, these tags become better targets for search algorithms. This, in turn, improves the quality of recommender systems. Improved metadata will enable more accurate statistical analysis of the shared data and trends in the user action.

Another benefit to tag-editing is that it can provide quick access to material of interest within a body of lengthy content, such as a video or textual document. Take for example, a lengthy video of a corporate seminar or surveillance footage of a shopping mall. A user may be interested in only a portion or portions of the video and would require quick access to the items of interest. In the example of surveillance footage, only the portion of the video showing a suspect would be of interest.

The community of users consists of all users with an interest in the content which the tags describe. In order to edit a tag, a user needs only to be registered and assigned an identification number (or other unique identifier) to edit the metadata or tags in a file or document. Within that community of users, an authorized user is an entity that is granted the ability and privileges by the owner (or creator) of the tag to edit the tag in a file. Such authorization can be given to all users by the owner (or creator) of the tag (editing is open to the public). The system optionally allows the owner of the tag to limit the amount of editing that occurs such as allowing only certain persons to edit the metadata or tags.

Users are allowed to collaborate to improve the quality of tags attached to shared content by allowing them to edit or delete previous tags. This method can be used for correcting or augmenting any kind of data or metadata, including tags, comments, annotations, subtitles, images or videos. Inaccuracies are filtered out and clutter is reduced. This method can be used for social collaboration applications or for other applications beyond this domain, such as collaborative visual monitoring, and collaborative closed caption generation for accessibility.

Videos are one type of content where the benefits of tag-editing can be readily discerned. This is because videos can be large, unwieldy and can encompass a wide range of topics. Users can tag specific time intervals within a video document, and specific spatial locations within video frames. Tag-edits can become valuable pointers to individual topics or objects of interest within the video. Through tag-editing, we can 1) delimit specific temporal intervals within a video; 2) identify specific spatial regions within the delimited intervals; and 3) attach a textual description to each spatial or temporal segment. Each delimited spatial/temporal segment can be identified by a URL allowing direct access and linking to locations within the content.

Although tag-editing can benefit other media content and document types, we will focus our discussion on tag-editing for video. Referring now to the drawings and to FIG. 1 in particular, we discuss an exemplary implementation of tag editing. Here we see a segment of a video 100 showing two celebrities. This video image 100 shows that two tags 102 and 104 have been created to identify the celebrities. The tags 102 and 104 were created using the pop-up window 106 seen in the lower right-hand corner of the video image 100. In this simple example, the tags 102 and 104 were added to identify the celebrities.

Users can add, edit and delete tags (102 and 104), and can edit or delete others' tags. Some other tags that have already been created for this video 100 are shown in the vertical overlay window 120 on the right-hand side.

The following section describes one implementation for creating, editing and deleting tags related to video sequences. The same system could be used for other types of media, such as tags for documents, music, images, photographs, medical images and 3-D visualizations, spoken-word documents, speech sequences, software code, HTML pages, processes (e.g., system management), maps, and so forth. In each case, the system involves a client-side capability (a system for displaying the content and capturing user interactions) and a server-side capability (a system for capturing the client interactions and for storing, querying, editing, and deleting user-generated metadata).

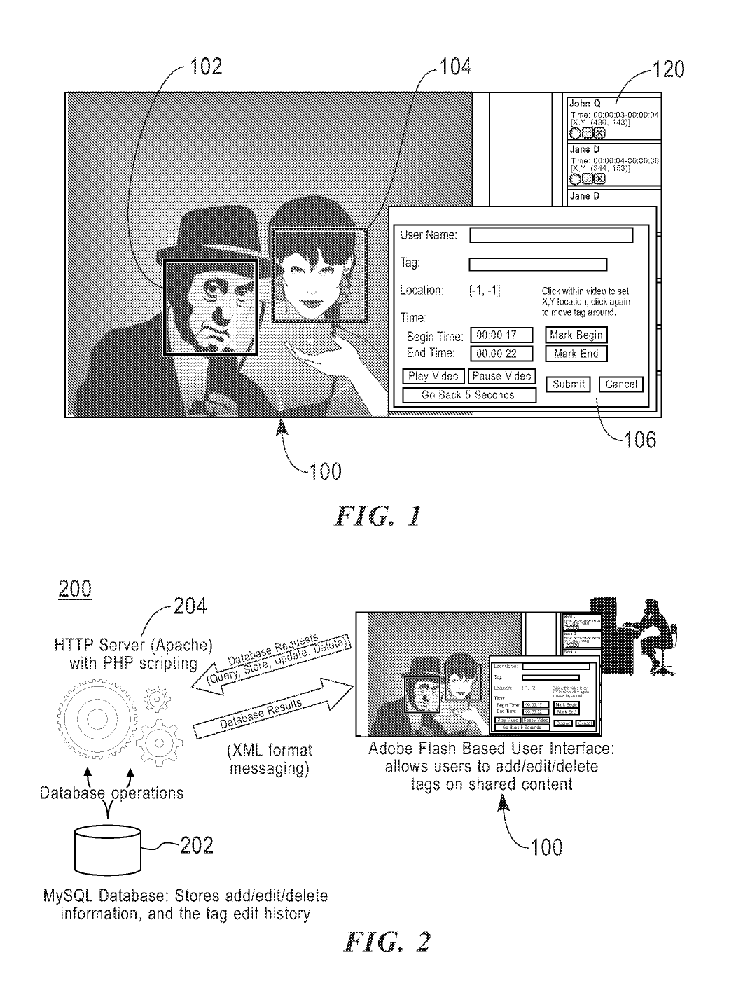

FIG. 2 shows a tag system 200 according to an embodiment of the invention, showing how tags can be created for clips of videos. This system incorporates a custom Adobe Flash/Flex based client player, running in a web browser, and a server application 204 for storing and retrieving the video and the tag-edited metadata. The server is built using an HTTP server (Apache), a database (MySQL) 202 and server-side scripting (PHP). The client player allows authorized users to enter tags and later these tags become accessible on the video or on a list on the display. Users can click on the tags on the display to edit them, or use the edit and delete buttons next to each tag on the list.

Server-side PHP scripts interpret the user's input and update the database 202 accordingly. The database 202 includes several tables for managing the micro-tags, such as a video table, a users table and a tags table for storing current tag information, and a table for storing the history of changes made on the tags. These tables can be mapped using the tag id.

Communication between the client and server is done using XML exchanged over HTTP connections. Any videos that are uploaded are stored in the filing system and also made available as a directory on the web server so they can be played back over HTTP when the client requests it.

In one embodiment the video is recorded in the flv format and delivered to the client using progressive download over HTTP. Keyframes were coded into the video at 1 second intervals which was also the granularity supported for the temporal locations that could be tagged. It is possible to seek to arbitrary locations using a specialized streaming server for the video rather than using HTTP. The temporal interval granularity can be refined also.

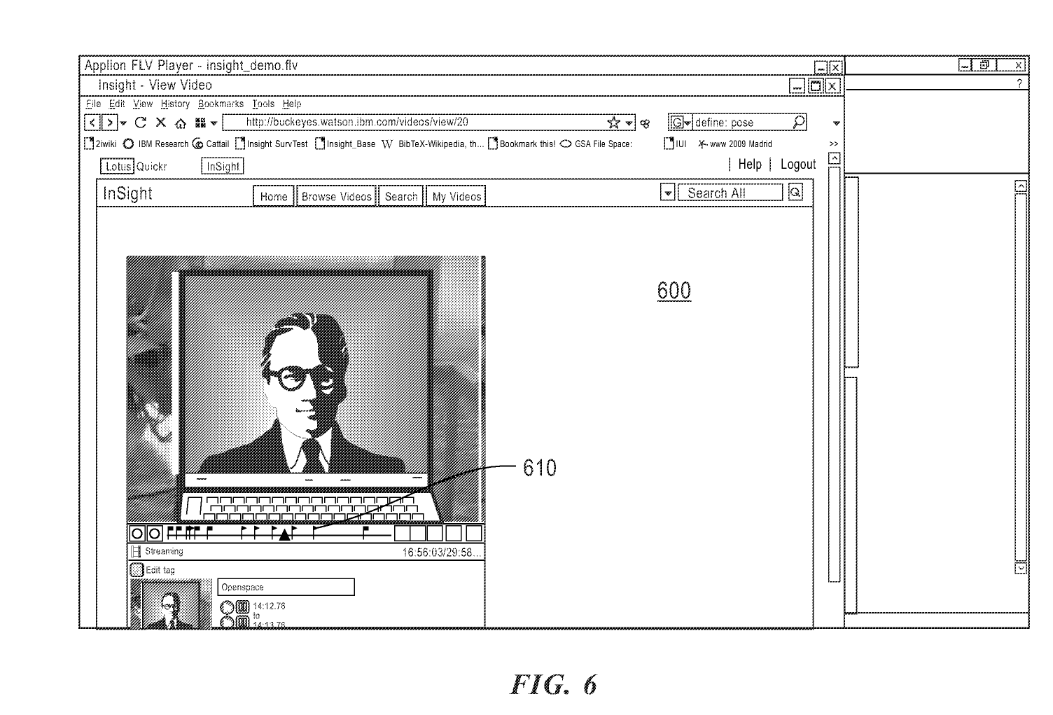

A video can have zero or more tags and each tag is associated with a textual description, and a temporal and spatial region of the video, which in this embodiment are stored as properties of the tag. Refer to FIG. 6 for an example of a video image 600 showing tag markers 610 along the timeline of the video image 600. The tag markers 610 in this example resemble flags and mark the location of each tag.

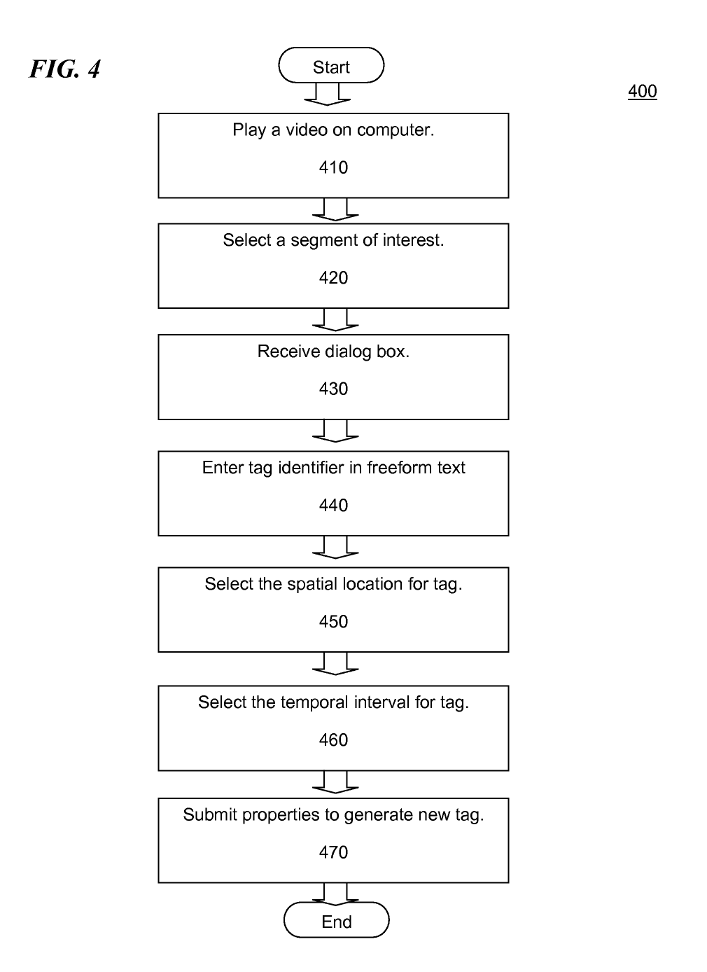

Referring now to the flow chart of FIG. 4, we describe how the tags 102 and 104 were created. In step 410 the user plays a video of interest. Next, in step 420 the user identifies a particular video segment of interest and clicks on the display screen to pause the video image. The user interaction causes a dialog box 106 to appear on the screen in step 430.

In this dialog box 106 the user is able to enter three descriptive properties of the tag: 1) the identifier; 2) the spatial location; and 3) the temporal location. You will note that in this example the spatial location and the temporal location will default to a pre-selected coordinate and the current temporal location, respectively. In step 440 the user enters the identifier which in this case is the name of the celebrity. The user enters “Jon Smith” in free form text.

Next in step 450 the user selects the spatial location for this tag 102. This may be as simple as accepting the default location. Or, in the alternative, the user in this example will place the tag 102 in proximity to the face of the celebrity. This can be done by clicking on the video image to set the spatial location. Once set, the tag can be “moved” by clicking on another location.

Now the user returns to the dialog box 106 in step 460 to set the temporal interval of the tag 102. In this instance, the default temporal location is exactly what the user wants, so the default is accepted. However, if the user wishes to override the default, the user can enter a different begin and end time and fix these temporal coordinates by clicking on the “MARK BEGIN” and “MARK END” buttons respectively. Alternatively, the user can simply click on the bottom button marked “GO BACK 5 SECONDS” to backtrack in five-second intervals.

Once the spatial and temporal locations are set, the user clicks on “SUBMIT” to create the tag 102 in step 470.

According to an embodiment of the invention, the usefulness of the tag-editing comes into play with the ability to edit the tags 102 and 104. We infuse micro-tagging with wiki-style editing. All three properties of this multi-dimensional tag can be edited. In this example, tag 102 contains a misspelling so we will focus on editing of the textual content of the tag. Textual artifacts in tag-editing can take the form of comments, sub-titles, captions, and other annotations. The user who created tag 102 incorrectly identified the celebrity as “Jon Smith” when in fact his name is spelled “John Smith.”

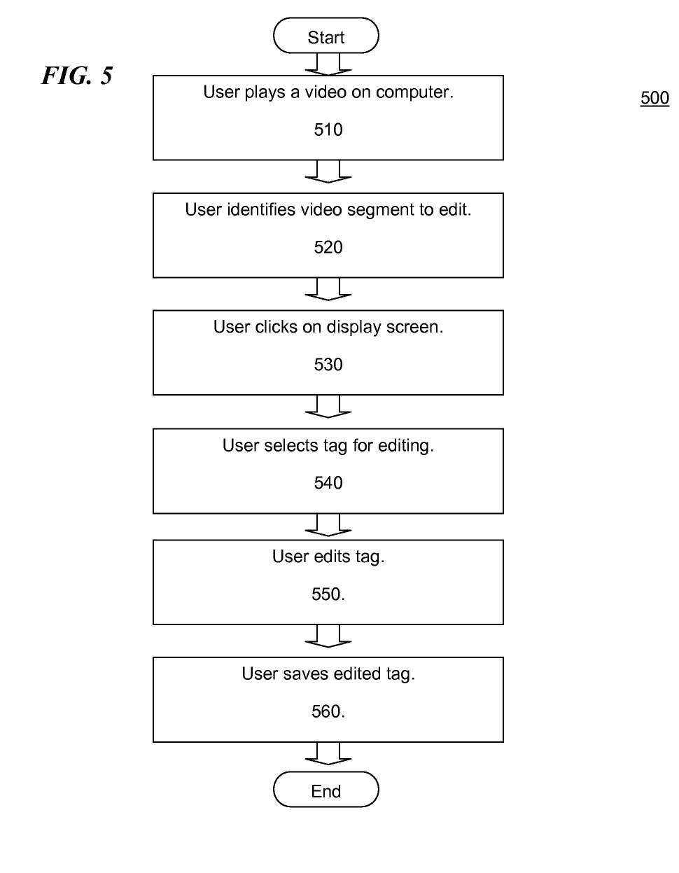

Referring now to the flow chart of FIG. 5, we describe how the tag 102 can be edited. First, in step 510, the user plays the video 100. Next, the user identifies the video segment of interest in step 520 which in this case is the image of the two celebrities from FIG. 1. The user then immediately clicks on his display screen to pause the video image in step 530. At this point any tags associated with this video segment 100 are listed in the overlay window 120 as shown in FIG. 1. In step 540 the user selects tag 102 for editing. This tag 102 box opens, showing the name of the celebrity. In step 550, the user corrects the misspelling, and saves the edited tag in step 560.

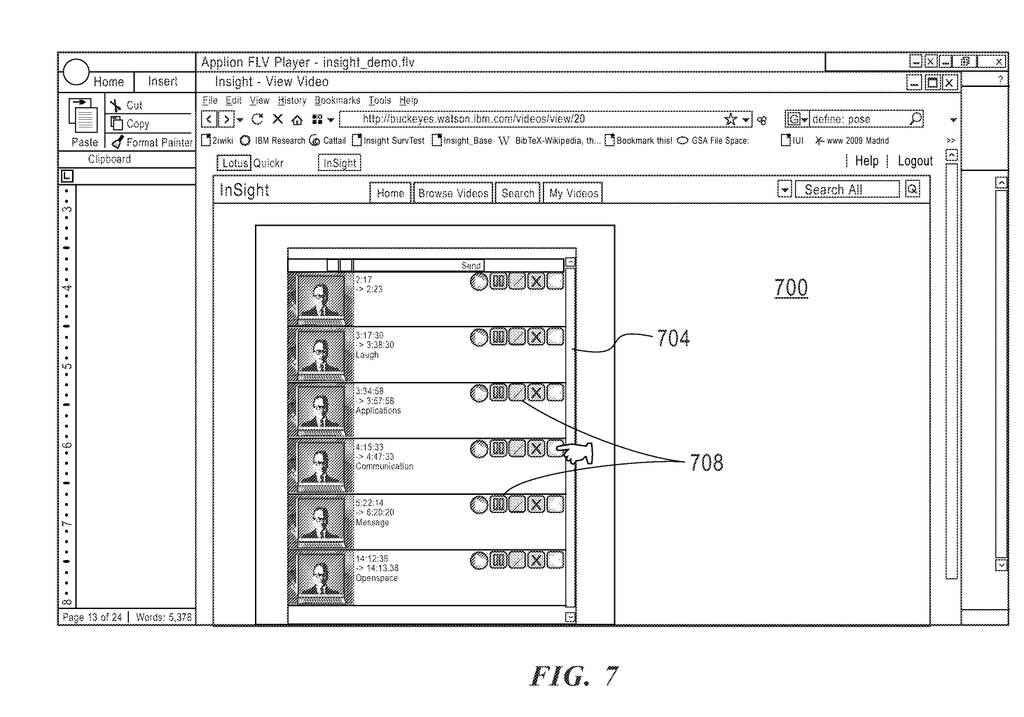

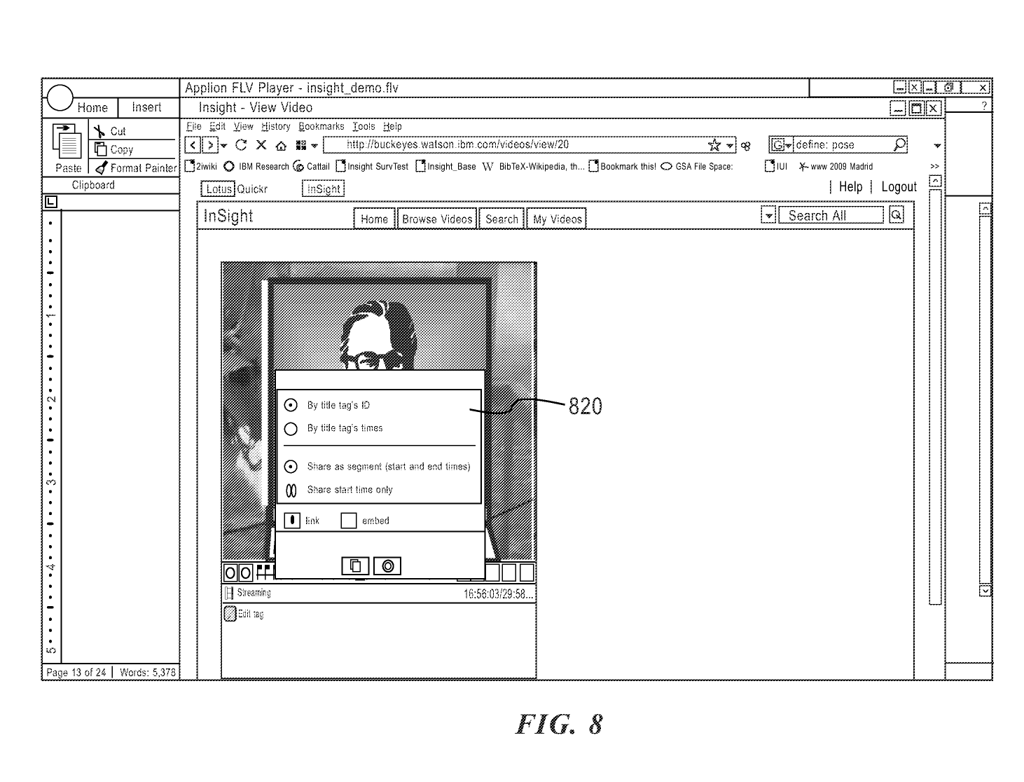

Referring now to FIG. 7, there is shown a screenshot displaying one method for a user to select a tag for editing. From the video image of FIG. 6, the user can click on a button to open the overlay window 700. This window 700 shows the list of all tags currently associated with this video image 600. You will note from this overlay window 700 that every tag also has an associated screenshot; whereas the overlay window 120 of FIG. 1 does not The screenshots are helpful for creating a visual memory of videos of the tags. Each screenshot is generated from the start time associated with the tag. You will note also the scroll bar 704 of this overlay window 700. This allows a user to scroll through the tags independent of the video image currently playing.

Each tag shown in this window 700 displays tag operation buttons 708, which in this example are: “jump to tag time and play,” “jump to tag time and pause,” “edit,” “delete,” and “share.”

After selecting a tag to edit from the overlay window 700, the user clicks on the edit button of the selected tag. This prompts a new dialog box, such as the box 106 shown in FIG. 1. In this box 106, a registered user is able to edit the tag label, change the begin and end times, and change the spatial location of the tag. Other tag properties are also contemplated within the spirit and scope of this invention. Concurrently with prompting the new dialog box, the video image 600 is paused at the start time shown in the tag. The user is able to continue playing the video while editing the tag. A new screenshot will not be taken for this edited tag unless the begin time is changed, since this tag being edited is already identified with a screenshot

Using the slider or scroll bar 704 on the bottom of the video image 600, the user can jump to another end time and hit “Mark End” to change the end time. The user then clicks ‘submit’ to save the edits.

Referring now to FIG. 8, clicking on the “share” option from among the tag operation buttons 708 prompts a new dialog box 820 where the user is able to select from several options. A user may select the option of a URL that will point directly to the tag. Other available options are: “format URL by tag ID,” “format URL by tag times,” “share as a segment—begin and end times only,” and “share start time only.” The default selection is “format URL by tag ID.” Clicking on the “copy to clipboard” button pastes this URL in the address bar, which reloads the video and directly jumps to the begin time of the video as delimited in the tag.

Tag-editing allows video content to be collaboratively indexed so that it can be directly searched and clips of interest found. For archival purposes, a history of tag editing changes can be kept on a server. This repository of old versions of the tags can be used for improving the search results by allowing the system to create an auxiliary index that will be used when the search on current tags fail. In addition, the log of changes will enable users to have access to history of changes, and rollback if needed.

Another application of this system is based on learning from the editing pattern of users. A collaborative editing scheme that focuses on editing or fixing the errors on specific labels will create a corpus of how typos are fixed, how connotations are interpreted (for example, we will have a pattern of how the name of a movie that the actor played matched to his name). This information could be used, for example, to train spell checking tools, improve information retrieval systems, or enhance electronic dictionaries (for synonyms).

Access control for editing others' tags can be set by an administrator or by the tag creator. Tags can be set as “editable” and/or “deletable.” Tag persistence can also be set according to its stability over time, that is, tags that have been “blessed” by the social community may develop immunity from editing and/or deletion. This “blessing” may be embodied as few or no edits over a period of time.

In one embodiment, we set three levels of access control: 1) users can see only their own tags; 2) users can see other's tags, but cannot edit or delete them; and 3) users can see, edit, and delete others' tags.

The access control system mimics three different types of available systems: private tagging mechanisms; currently available collaborative tagging systems; and Wikipedia.

Each modification to a tag is recorded so a change history is available. The history of changes can be kept on a server.

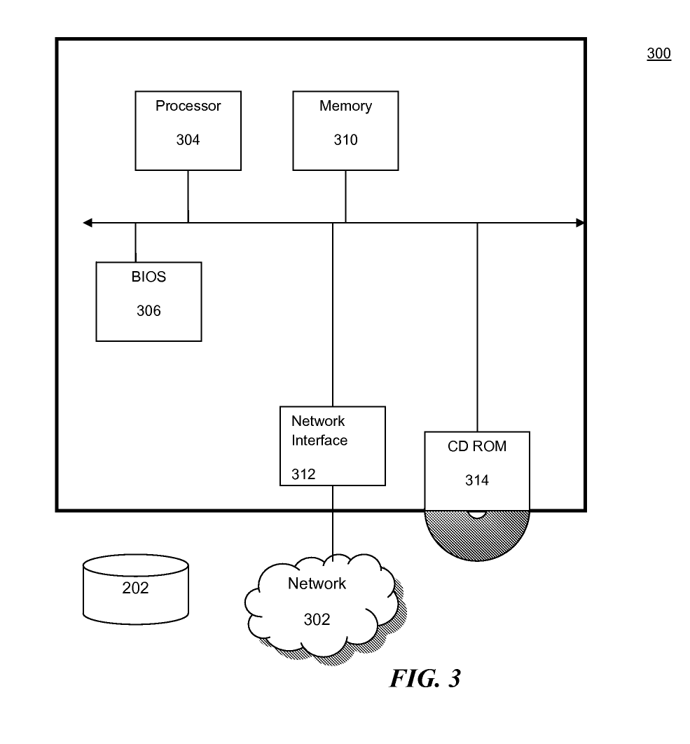

In an embodiment of the invention shown in FIG. 3, a computer system 300 (an information processing machine) is illustrated for exemplary purposes as a networked computing device. As will be appreciated by those of ordinary skill in the art, aspects of the invention may be distributed amongst one or more networked computing devices which interact with computer system 300 via one or more data networks such as, for example, network 302. However, for ease of understanding, aspects of the invention have been embodied in a single computing device—computer system 300.

The computer system 300 is in communication with other networked computing devices (not shown) via network 302. As will be appreciated by those of ordinary skill in the art, network 302 may be implemented using conventional networking technologies and may include one or more of the following: local area networks, wide area networks, intranets, public Internet and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Computer system 300 includes one or more processors 304 which communicate with various input devices 306, output devices 308 and network 302. Input devices 306 may include, for example, a keyboard, a mouse, a scanner, an imaging system (e.g., a camera, etc.) or the like. Similarly, output devices may include displays, information display unit printers and the like. Additionally, combination input/output (I/O) devices may also be in communication with processing system 304. Examples of conventional I/O devices include removable and fixed recordable media (e.g., floppy disk drives, tape drives, CD-ROM drives, DVD-RW drives, etc.), touch screen displays and the like.

As illustrated, processing system 300 includes several components—central processing unit (CPU) 304, memory 310, network interface (I/F) 312 and I/O I/F 314. The client can also be a mobile device without a memory such that the metadata being edited resides in the server. Each component is in communication with the other components via a suitable communications bus as required.

CPU 304 comprises at least one processing unit, such as an Intel Pentium™, IBM PowerPC™, Sun Microsystems UltraSparc™ processor or the like, suitable for the operations described herein. As will be appreciated by those of ordinary skill in the art, other embodiments of processing system 102 could use alternative CPUs and may include embodiments in which one or more CPUs are employed. CPU 304 may include various support circuits to enable communication between itself and the other components of processing system 102.

Memory 310 includes both volatile and persistent memory for the storage of: operational instructions for execution by CPU 304, data registers, application storage and the like. Memory 310 preferably includes a combination of random access memory (RAM), read only memory (ROM) and persistent memory such as that provided by a hard disk drive.

Alternatively, some or all of the sub-processors may be implemented in an ASIC. RAM may be embodied in one or more memory chips. The memory may be partitioned or otherwise mapped to reflect the boundaries of the various memory subcomponents.

The memory 310 represents either a random-access memory or mass storage. It can be volatile or non-volatile. The system 300 can also comprise a magnetic media mass storage device such as a hard disk drive.

What has been shown and discussed is a highly-simplified depiction of a programmable computer apparatus. Those skilled in the art will appreciate that a variety of alternatives are possible for the individual elements, and their arrangement, described above, while still falling within the scope of the invention. Thus, while it is important to note that the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of signal bearing media include ROMs, DVD-ROMs, and transmission-type media, such as digital and analog communication links, wired or wireless communications links using transmission forms, such as, for example, radio frequency and light wave transmissions. The signal bearing media may take the form of coded formats that are decoded for use in a particular data processing system.

According to another embodiment of the invention, a computer readable medium, such as a CDROM 314 can include program instructions for operating the programmable computer 300 according to the invention. What has been shown and discussed is a highly-simplified depiction of a programmable computer apparatus. Those skilled in the art will appreciate that other low-level components and connections are required in any practical application of a computer apparatus.

It should be understood that the invention is not limited to the embodiments described above, but rather should be interpreted within the full meaning and scope of the appended claims.

We claim:

1. A server-side method for editing metadata in a file, the method comprising:
receiving from a registered user, a request for editing the metadata in the file;
presenting a window to the user for display on a user's screen wherein the window displays properties of the metadata;
receiving from the user an edit to the metadata properties; and
updating the metadata properties with the edit received from the user, for producing an updated metadata.

2. The method of claim 1 wherein the file is selected from a group of file types consisting of: text, image, audio, and video.

3. The method of claim 1 wherein updating the metadata properties comprises updating at least one property selected from a group consisting of: an identifier of the metadata, a temporal interval of the metadata, and a spatial location of the metadata.

4. The method of claim 1 wherein the metadata is set as editable, wherein editable means that any user can edit the metadata.

5. The method of claim 1 wherein the edit ability of the metadata decreases as a function of its stability over time.

6. The method of claim 1 wherein the file is in a social network.

7. The method of claim 1 wherein the updating step comprises adding a tag to the file at the selected part of the screen.

8. The method of claim 1 wherein the updating step comprises editing a tag in the file at the selected part of the screen.

9. The method of claim 1 wherein the updating step comprises deleting a tag in the file at the selected part of the screen.

10. The method of claim 1 wherein the updating step comprises adding a comment to the file at the selected part of the screen.

11. The method of claim 1 wherein the updating step comprises typing in the text box at the selected part of the screen.

12. The method of claim 3 wherein the updating step comprises updating the temporal interval of the metadata to a current video time.

13. The method of claim 1 wherein the step of presenting the window comprises presenting the window with timeline markers wherein each timeline marker represents a temporal segment of the file.

14. The method of claim 1 wherein the user is any user.

15. The method of claim 1, further comprising a step of:
storing both the metadata and the updated metadata in a data store.

16. The method of claim 1 wherein the updating step comprises editing a caption in the file at the selected part of the screen.

17. A client-side method for editing a file, comprising:
submitting a request by a user in a social network, to edit metadata of a file;
receiving a pop-up box comprising at least one section for editing properties of the portion of the file;
entering an edit to at least one of the properties of the metadata of the file selected; and
submitting the at least one edit.

18. The method of claim 17 wherein the file is selected from a group of file types consisting of: text, image, audio, and video.

19. The method of claim 17 wherein submitting the request comprises clicking on a display screen.

20. The method of claim 17 wherein receiving the pop-up box comprises receiving the pop-up box comprising an identifier section, a temporal interval section, and a spatial location section, for editing.

21. The method of claim 17 wherein entering the edit comprises entering the edit to the identifier section by entering free-form text.

22. The method of claim 17 wherein entering the edit comprises entering the edit to the temporal interval section by selecting one of three actions consisting of: accepting a default temporal interval; entering a specific start and end time; and selecting a temporal interval in a specific past interval of time.

23. The method of claim 17 wherein entering the edit comprises entering the edit to the spatial location section by selecting an action consisting of: accepting a default spatial location; entering a specific location coordinate; and clicking on a location of the file viewable to the user.

24. The method of claim 23 further comprising changing the selected spatial location by clicking on another location of the file viewable to the user.

25. A computer readable storage device comprising software that when executed by a processor causes the processor to perform a method comprising:
receiving from a user, a request to edit a tag in a file;
sending a screen from the file to the user for display on a user's display wherein the screen displays at least one tag;
receiving from the use, an edit to the tag; and
modifying the tag with the user edit to produce an edited tag.

26. An information processing server machine comprising:
an interface configured for: receiving from a user, a request to edit a tag in a file and receiving from the user, an edit to the tag;
a processor configured for modifying the tag with the received edit; and
an output device configured for sending a screen from the file to the user for presentation on a user's display wherein the screen displays at least one tag.
